(19) United States
(12) Patent Application Publication
(10) Pub. No.: US 2026/0233602 A1
(43) Pub. Date: Aug. 13, 2026

(54) Method and System for Dialog Control for a Motor Vehicle

(71) Applicant: Bayerische Motoren Werke Aktiengesellschaft, Muenchen (DE)

(72) Inventors: Mathias Ordung, Muenchen (DE); Jan Schmale, Muenchen (DE)

(21) Appl. No.: 19/151,578

(22) PCT Filed: Nov. 27, 2023
(86) PCT No.: PCT/EP2023/083108

§ 371 Date: Jul. 28, 2025

(30) Foreign Application Priority Data
Feb. 10, 2023 (DE) 10 2023 103 302.6

(51) Int. Cl. B60K 35/10; B60K 35/22; B60K 35/25; B60K 35/26

(52) U.S. Cl. CPC B60K 35/10; B60K 35/22; B60K 35/25; B60K 35/26; B60K 2360/178

(57) ABSTRACT

A method for dialog control for a motor vehicle includes a step of, after an event has occurred, determining a selection of a plurality of options relating to a notification function for the motor vehicle. The method also includes providing the selection for user input at a first human-machine interface by outputting first signals of a first type. The user input is captured at a second human-machine interface. The user input has second signals of a second type and identifies the selected option. The selected option is activated.

The present application is the U.S. national phase of PCT Application PCT/EP2023/083108 filed on Nov. 27, 2023, which claims priority of German patent application No. 10 2023 103 302.6 filed on Feb. 10, 2023, the entire contents of which are incorporated herein by reference.

### TECHNICAL FIELD

The present disclosure relates generally methods and systems for dialog control for a motor vehicle.

### BACKGROUND

In modern motor vehicles, human-machine interfaces are used. These include displays, through which vehicle occupants can receive information or else make inputs. For example, navigation routes are displayed via such displays. The vehicle occupant can input the start, destination and also other details by means of an input via the display. Such displays can be located in a region of a center console, behind a headrest of a driver or front passenger and/or, from the driver's view, behind the steering wheel, or by projection on a surface, in particular on a windshield, as what is known as a head-up display. Meanwhile, functions of the motor vehicle can also be actuated by audible inputs using voice recognition.

There is always a need for facilitating improved dialog control for a motor vehicle.

### SUMMARY

At least some embodiments address the above-stated need, as well as others, using the methods and system described herein.

A first aspect of the solution relates to a method, which may be a computer-implemented method, for dialog control for a motor vehicle, having the following automated steps: (i) determining after an event, in particular a driving situation, has occurred, a selection of a plurality of options, in particular activating or deactivating a notification, relating to a notification function; (ii) providing the selection for user input at a first human-machine interface by outputting first signals of a first type; (iii) capturing the user input, which comprises second signals of a second type, at a second human-machine interface; (iv) activating the selected option.

The terms “comprises”, “contains”, “includes”, “involves”, “has”, “having” or any other variant thereof, as may be used herein, are intended to cover a non-exclusive inclusion. For instance, a method or an apparatus that comprises or has a list of elements is not necessarily restricted to these elements but can include other elements that are not listed explicitly or are inherent to such a method or apparatus.

In addition, unless explicitly stated otherwise, “or” refers to an inclusive or and not to an exclusive “or”. For example, a condition A or B is satisfied by one of the following conditions: A is true (or is present) and B is false (or not present), A is false (or not present) and B is true (or present), and both A and B are true (or present).

The terms “a” or “an” as used herein are defined in the sense of “one or more”. The terms “another” and “a further” and any other variant thereof shall be understood to mean “at least one further”.

The term “plurality” as used here shall be understood to mean “two or more” .

The term “configured” or “set up” to perform a certain function (and variants thereof) as used here shall be understood to mean that the relevant apparatus already exists in a form or setting in which it can carry out the function, or at least can be adjusted, i.e. configured, such that it can carry out the function after suitable adjustment. For example, the configuration can be made by way of suitable adjustment to parameters of a process flow or to switches or the like for activating and/or deactivating functionalities or settings. In particular, the apparatus can have plurality of predefined configurations or operating modes, SO that the configuring can be performed by selecting one of these configurations or operating modes.

The term “type of signal” as used here refers in particular to a physical property of the given signal. In particular, a type of signal can be a visual signal, an audible signal, a haptic signal or a signal based on gesture.

The term “visual signals” as used here refers in particular to electromagnetic signals that can be perceived by the human eye. This perception can occur in particular for electromagnetic waves in a wavelength range of approximately 400 nm to 760 nm. In particular, visual signals can be used to present content in a visible manner to a user by means of a display. term “audible signals” as used here refers in particular to signals based on sound waves, in particular those sound waves that can be perceived by the human ear. It can also refer to sound waves produced by the human voice, in particular spoken language.

The term “haptic signals” as used here refers in particular to signals that result from a human hand, or another part of the human body, touching an object, in particular an object in a motor vehicle. In particular, a function of the motor vehicle can be initiated by a haptic signal, in particular by a human hand. Equally, the haptic signal can include a movement, in particular a vibration of an object of the motor vehicle, which haptic signal can be perceptible by a user.

The term “gestural signal” as used here refers in particular to controlling or initiating a function through recognition of a gesture by a user, in particular by a camera in a motor vehicle.

The term “human-machine interface” as used here refers to input devices or operating controls via which a user can initiate a function. In a motor vehicle, these input devices can include in particular steering wheel, pedals and manually operable mechanical or electrical operating controls such as, for instance, pushbuttons, knobs, levers, sliding or rotary controls, touch-sensitive surfaces (e.g. trackpads) or screens (touchscreens). In addition, a human-machine interface can include in particular voice control, which can be designed to distinguish and recognize a narrowly confined, cataloged set of predefined voice instructions. Furthermore, a human-machine interface can include in particular sensor-assisted, in particular camera-assisted, recognition of individual hand gestures for controlling selected vehicle functions.

The term “event” as used here refers in particular to a specific driving situation such as exceeding a stipulated speed. Equally, an “event” can refer in particular to starting the engine or initiating a function in the motor vehicle, for instance initiating a windshield wiper or initiating an air-conditioning system.

The method according to the first aspect can achieve greater flexibility and hence situation-optimized adaptation regarding the output of a selection of options and a subsequent user input for selecting an option. This can be achieved by the use of different types of signals, namely a first type of first signals and a second type of second signals. Hence another type of signal can be used for the providing than for the receiving.

Exemplary embodiments of the method are described below, each of which can be combined in any way with one another and with the further other aspects described, unless this is explicitly ruled out or technically impossible.

In some embodiments, the method further includes that determining a future selection relating to the same notification function takes into account the selected option. By taking into account a selected option that has already been made, it is possible to determine an improved future selection of options.

In some embodiments, the determining of the selection is performed by an analysis device located outside the motor vehicle, and the determined selection is transferred to the first human-machine interface of the motor vehicle for providing the selection. The analysis device located outside the motor vehicle means that the computing power needed for the determining can be cut in the motor vehicle. At the same time, an analysis device located outside the motor vehicle can be equipped with comparatively large capacities and an associated higher computing power. This allows faster and/or more comprehensive determination of the selection of the options.

In some embodiments, the analysis device takes into account the event that has occurred to define the first type of the first signals and the second type of the second signals. It can be stipulated here in particular that for driving-critical events such as unexpected braking, a visual signal is defined as the first type for providing the selection so as not to distract a driver unnecessarily, which might be the case for an audible signal. In such a case, the driver could select at a later time by a voice signal an option from the selection. This allows better adaptation of the use of the first type of the first signals and the second type of the second signals according to the event.

In some embodiments, prioritization, in particular in terms of time or the presentation, regarding the notification function is made as a result of the selected option. The capture of the user input can thereby actively influence that the notification function is prioritized in future. This can mean that the notification function takes place more often or that the notification function is made audibly in order to improve perception by the user.

In some embodiments, the first type of the first signals or the first type of the second signals is selected from the group comprising visual, audible, gestural or haptic. The providing of the selection by visual signals, in particular by a display, can be advantageous for presenting plurality of options simultaneously. An audible signal can be perceived more strongly by a user. A user input by a voice signal, in particular a word or a short instruction, can be advantageous in particular for a driver, because then he does not have to take his hands off the steering wheel. A haptic signal, in particular via a steering wheel, can be advantageous for the driver because he does not have to take his eyes off the road. A signal by a gesture can be made intuitively by the user.

A second aspect of the solution relates to a system for dialog control for a motor vehicle, wherein the system is configured to perform the method according to the first aspect, wherein the system has a vehicle-based apparatus of the motor vehicle and an analysis device, which is located outside the motor vehicle, and which is connected for signal communication to the vehicle-based apparatus of the motor vehicle.

A third aspect relates to a computer program containing instructions which, on being executed on a system according to the second aspect, cause it to perform the method according to the first aspect.

In particular, the computer program can be stored on a non-volatile data storage medium. This is preferably a data storage medium in the form of an optical data storage medium or a flash memory module. This can be advantageous when the computer program as such is meant to be handled independently of a processor platform on which the one program or the plurality of programs are to be executed. In another implementation, the computer program can be available as a file on a data processing unit, in particular on a server, and can be downloaded via a data connection, for example the Internet or dedicated data connection, for instance a proprietary or local area network. In addition, the computer program can have a plurality of interacting individual program modules. In particular, the modules can be configured, or at least can be set up, such that they are implemented in the sense of distributed computing on different devices (computers or processing units) that are geographically spaced from each other and can be connected together via a data network.

The system, in particular the analysis device, can accordingly have a program memory in which the computer program is stored. Alternatively, the system can also be set up to access via a communication connection an external computer program that is available, for example, on one or more servers or other data processing units, in particular in order to exchange therewith data that is used during the course of the method or the computer program or constitutes outputs from the computer program.

The features and advantages explained with reference to the first aspect of the solution also apply correspondingly to the further aspects described.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows schematically a flow diagram for illustrating a preferred embodiment of a method for operating a system for a motor vehicle; and

FIG. 2 shows schematically a block diagram of a system according to one embodiment.

### DETAILED DESCRIPTION

The same reference signs are used consistently in the figures for the same or corresponding elements.

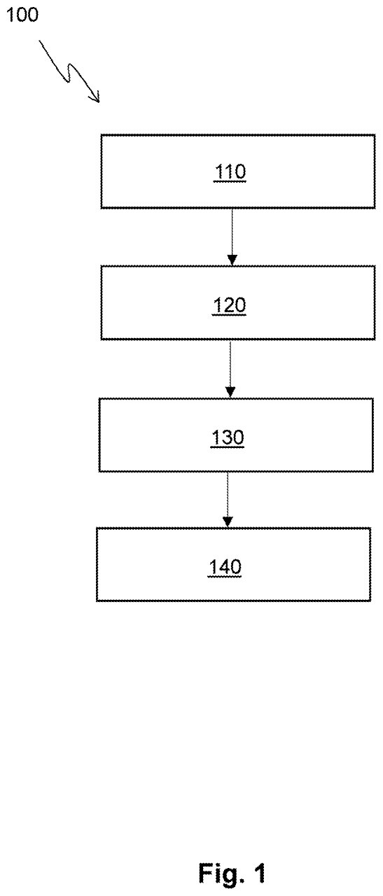

FIG. 1 shows schematically a flow diagram 100 for illustrating a preferred embodiment of a method for dialog control for a motor vehicle having the following automated steps:

In a first step 110 of the method, after an event has occurred, a selection of a plurality of options relating to a notification function for the motor vehicle is determined by an analysis device 240, which is located outside the motor vehicle. The options here can include activating or deactivating the notification function. Equally, an option can mean that the notification function is displayed in a defined time interval.

In a further step 120 of the method, the selection for user input is provided at a first human-machine interface by outputting first signals of a first type. In particular, the providing can be effected by displaying contents by means of a display.

In a further step 130 of the method, the user input, captured at a second human-machine interface. The second signals of the second type can include audible signals, in particular a voice instruction by the user.

In a further step 140 of the method, the selected option is activated.

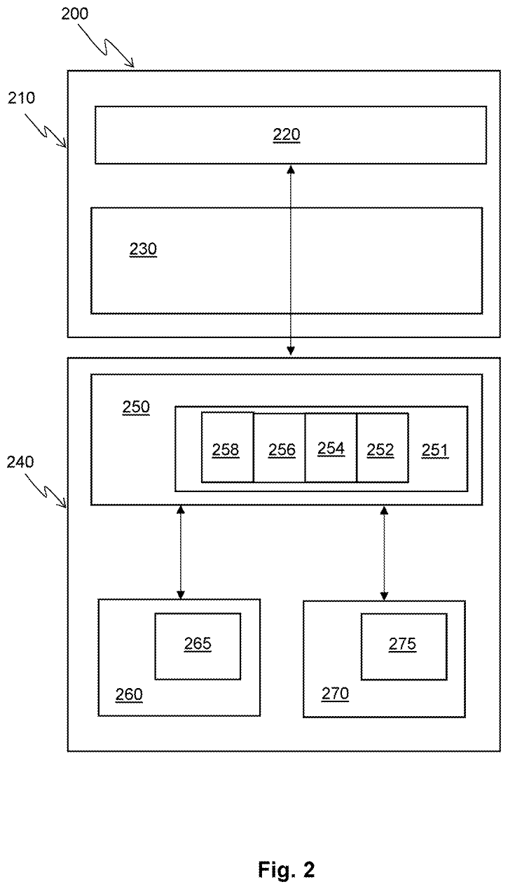

FIG. 2 shows schematically a block diagram of a system 200 according to one embodiment.

The system 200 has a vehicle-based apparatus 210 of a motor vehicle (not shown here) and an external analysis device 240 located outside the motor vehicle. The vehicle-based apparatus 210 is connected for signal communication to the external analysis device 240, in particular by a radio connection, in particular based on a cellular radio standard such as LTE or 5G, for example. This is shown schematically by the respective arrows.

The vehicle-based apparatus 210 has a human-machine interface system 220 having at least a first human-machine interface and a second human-machine interface. The first human-machine interface can output information to a user by means of a first type of signals, and the second human-machine interface can receive a user input by means of a second type of second signals. The first type of the first signals and the second type of the second signals can be visual, audible, gestural or haptic. It is intended here that the output and the subsequent user input is performed by means of different types of signals. For example, the output can be made by displaying on a display, whereas the user input can be made acoustically by means of voice. As part of the output, the user is displayed a selection of options, from which the user can select an option by means of an input, thereby initiating a function in the motor vehicle. The determining of the selection of the options is initiated by an event, for instance by the motor vehicle driving too fast. As a result of this event, the event is captured in a conditioning module 230 and undergoes signal conditioning for transmission to the skill module in order to determine the selection.

The selection of the options is determined in the external analysis device 240, and sent to the vehicle-based apparatus 210 for output. The information about the selected option is sent back to the external analysis device 240 for determining a future selection.

In addition, information about automated warning messages in the motor vehicle is also, for instance notifications about exceeding a speed or about a status of the motor vehicle.

The external analysis device 240 has a plurality of analysis algorithms, which are used, individually or in combination, to determine the selection of the options. The analysis algorithms are ideally held in a Cloud memory, allowing flexible access in terms of location.

The analysis algorithms include a skill network module 250, also known as a skill router. This skill network module 250 has a plurality of modules, in particular a dialog persistence module 252, a routine logic module 254, a modality management module 256, and an interaction feedback module 258. The determined results from the individual modules 252, 254, 256, 258 mentioned are combined in a skill integration module 251, from which the selection options that is sent to the human machine interface system 220 for output by the first human-machine interface is determined.

In order to determine the selection of options, an information exchange also takes place between the skill network module 250 and both a speech formation module 260 and a skill design runtime module 270, which comprises a skill management module 275. The speech formation module 260 comprises a dialog management module 265. It can thereby be specified, for example, whether an already conveyed message is meant to be repeated. Likewise, the dialog management module 265 can specify whether the next message is meant to be made audibly via a loudspeaker in the motor vehicle or visually via a display.

By means of the information received in the skill network module 250 through the user input at the second human-machine interface and, if applicable, further information about a current status in the motor vehicle, the algorithms of the external analysis device 240, in particular the skill network module 250, determine which selection of options is provided to the user. Thus the skill network module 250 does not generate a notification for transfer to the first human-machine interface. A current notification is also coupled to a selection as to how to handle a future notification. For example, the user can select whether in future this notification is meant to be deactivated or is meant to be made regularly.

In this sense, the user can take via the selection of the options to the type and frequency of future notifications. The information received by the skill network module 250 is analyzed in parallel for this purpose. As a result, the selection of the options is continuously optimized, as are the notifications made to the user.

Furthermore, the dialog management module 258 controls in which signal type a next output for the same function is meant to be made.

In addition, a first notification can be made audibly, and a second notification, which relates to the same theme, can be made only visually at a later time.

For example, taking into account legal regulations, a function that is not allowed to be permanently deactivated can be manually deactivated by a provided option at the start of every journey. In this regard, settings for the motor vehicle can be made in a semi-automated manner, so that the user is offered a plurality of options, and the user makes a setting at the motor vehicle through the appropriate selection.

While at least one exemplary embodiment has been described above, it should be noted that a large number of variations thereof exist. It should also be mentioned that the described exemplary embodiments constitute only non-limiting examples, and it is not intended for these to restrict the scope, applicability or configuration of the apparatuses and methods described herein. In fact, the above description will provide a person skilled in the art with guidance on implementing at least one exemplary embodiment, with it being understood that various changes to the manner of operation and arrangement of the elements described in an exemplary embodiment can be made without thereby departing from the subject matter specified in each of the accompanying claims or from its legal equivalent.

### LIST OF REFERENCES

100 flow diagram for illustrating a preferred embodiment of a method
110 determining a selection
120 providing the selection
130 capturing a user input
140 activating an option
200 system
210 vehicle-based apparatus
220 human-machine interface system
230 conditioning module
240 analysis device
250 skill network module
251 skill integration module
252 dialog persistence module
254 routine logic module
256 modality management module
258 interaction feedback module
260 speech formation module
265 dialog management module
270 skill design runtime module
275 skill management module

1.-8. (canceled)

9. A method for dialog control for a motor vehicle, the method comprising:
after an event has occurred, determining a selection of a plurality of options relating to a notification function for the motor vehicle;
providing the selection for user input at a first human-machine interface by outputting first signals of a first type;
capturing the user input, which comprises second signals of a second type, at a second human-machine interface, the user input identifying a selected option; and
activating the selected option.

10. The method as claimed in claim 9, further comprising determining a future selection relating to a same notification function based at least in part on the selected option.

11. The method as claimed in claim 10, wherein the determining of the selection is performed by an analysis device located outside the motor vehicle, and the determined selection is transferred to the first human-machine interface of the motor vehicle for providing the selection.

12. The method as claimed in claim 9, wherein the determining of the selection is performed by an analysis device located outside the motor vehicle, and the determined selection is transferred to the first human-machine interface of the motor vehicle for providing the selection.

13. The method as claimed in claim 12, wherein the analysis device takes into account the event that has occurred to define the first type of the first signals and the second type of the second signals.

14. The method as claimed in claim 9, wherein providing the selection for user input at the first human-machine interface by outputting the first signals of the first type further comprises determining the first type of the first signals based at least in part on the event.

15. The method as claimed in claim 9, further comprising determining the second type of the second signals based at least in part on the event.

16. The method as claimed in claim 9, further comprising determining a prioritization regarding the notification function based at least in part on the selected option.

17. The method as claimed in claim 16, further comprising determining a future selection relating to a same notification function based at least in part on the selected option.

18. The method as claimed in claim 9, wherein the first type of the first signals or the first type of the second signals is selected from the group consisting of visual signals, audible signals, gestural signals and haptic signals.

19. The method as claimed in claim 18, wherein the first type of the first signals is selected form the group consisting of visual signals and audible signals, and the second type of the second signals is selected from the group of audible signals and gestural signals.

20. A system for dialog control for a motor vehicle, wherein the system is configured to perform the method as claimed in claim 9.

21. The system of claim 20, wherein the system comprises:
a vehicle-based apparatus of the motor vehicle and an analysis device, which is located outside the motor vehicle; and
wherein the analysis device is connected for signal communication to the vehicle-based apparatus of the motor vehicle, and the analysis device is configured to perform determining the selection of the plurality of options relating to the notification function for the motor vehicle.

22. The system as claimed in claim 21, wherein the analysis device takes into account the event that has occurred to define the first type of the first signals and the second type of the second signals.

23. A non-transitory computer readable medium having instructions which, on being executed by a processor, performs:
after obtaining information that an event has occurred, determining a selection of a plurality of options relating to a notification function for a motor vehicle;
sending first information causing the selection for user input to be provided at a first human-machine interface in the motor vehicle by outputting first signals of a first type;
and wherein the first information causes capturing the user input, which comprises second signals of a second type, at a second human-machine interface in the motor vehicle, the user input identifying a selected option;
wherein sending the first information comprises sending the information to the motor vehicle wherein the motor vehicle is configured to activate the selected option.
